(19) United States
(12) Patent Application Publication
(10) Pub. No.: US 2026/0067810 A1
(43) Pub. Date: Mar. 5, 2026

(54) ENERGY HARVESTING DEVICES ESTIMATED ACTIVE TIME FOR PAGING RECEPTION

(71) Applicant: Nokia Technologies Oy, Espoo (FI)

(72) Inventors: Navin HATHIRAMANI, Coppell, TX (US); Mikko SÄILY, Espoo (FI)

(21) Appl. No.: 19/106,723

(22) PCT Filed: Aug. 1, 2023
(86) PCT No.: PCT/IB2023/057802

§ 371 Date: Feb. 26, 2025

Related U.S. Application Data
(60) Provisional application No. 63/402,283, filed on Aug. 30, 2022.

(51) Int. Cl. H04W 52/02; H02J 50/00; H02J 50/20; H04W 68/00; H04W 76/27

(52) U.S. Cl. CPC H04W 52/0229; H02J 50/001; H02J 50/20; H04W 68/005; H04W 76/27

(57) ABSTRACT

Systems, methods, apparatuses, and computer program products for providing estimated active time for paging reception for energy harvesting devices are provided. For example, a method can include receiving a radio resource control release message from a network. The method can also include sending an acknowledgment message to the network in response to the release message. The acknowledgment message can include an estimated active time of the apparatus.

### FIELD

Some example embodiments may generally relate to communications including mobile or wireless telecommunication systems, such as Long Term Evolution (LTE) or fifth generation (5G) radio access technology or new radio (NR) access technology, or other communications systems including subsequent generations of the same or similar standards. For example, certain example embodiments may generally relate to providing estimated active time for paging reception for energy harvesting devices.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on 5G new radio (NR), but a 5G (or NG) network can also build on the E-UTRA radio. From release 18 (Rel-18) onward, 5G is referred to as 5G advanced. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio. 6G is currently under development and may replace 5G and 5G advanced.

### SUMMARY

An embodiment may be directed to an apparatus. The apparatus can include at least one processor and at least one memory storing instructions. The instructions, when executed by the at least one processor, can cause the apparatus at least to perform receiving a radio resource control release message from a network. The instructions, when executed by the at least one processor, can also cause the apparatus at least to perform sending an acknowledgment message to the network in response to the release message. The acknowledgment message can include an estimated active time of the apparatus.

An embodiment may be directed to an apparatus. The apparatus can include at least one processor and at least one memory storing instructions. The instructions, when executed by the at least one processor, can cause the apparatus at least to perform sending a radio resource control release message to a user equipment. The instructions, when executed by the at least one processor, can also cause the apparatus at least to perform receiving an acknowledgment from the user equipment in response to the release message. The acknowledgment message can include an estimated active time of the user equipment.

An embodiment may be directed to an apparatus. The apparatus can include at least one processor and at least one memory storing instructions. The instructions, when executed by the at least one processor, can cause the apparatus at least to perform receiving, from a radio access network node, an estimated active time of a user equipment. The instructions, when executed by the at least one processor, can also cause the apparatus at least to perform considering the user equipment as reachable during a period of time corresponding to the estimated active time.

An embodiment may be directed to a method. The method can include receiving, at a user equipment, a radio resource control release message from a network. The method can also include sending, by the user equipment, an acknowledgment message to the network in response to the release message. The acknowledgment message can include an estimated active time of the user equipment.

An embodiment may be directed to a method. The method can include sending, by a network, a radio resource control release message to a user equipment. The method can also include receiving, at the network, an acknowledgment from the user equipment in response to the release message. The acknowledgment message can include an estimated active time of the user equipment.

An embodiment may be directed to a method. The method can include receiving, from a radio access network node, an estimated active time of a user equipment. The method can also include considering the user equipment as reachable during a period of time corresponding to the estimated active time.

An embodiment can be directed to an apparatus. The apparatus can include means for receiving a radio resource control release message from a network. The apparatus can also include means for sending an acknowledgment message to the network in response to the release message. The acknowledgment message can include an estimated active time of the apparatus.

An embodiment can be directed to an apparatus. The apparatus can include means for sending a radio resource control release message to a user equipment. The apparatus can also include means for receiving an acknowledgment from the user equipment in response to the release message. The acknowledgment message can include an estimated active time of the user equipment.

An embodiment can be directed to an apparatus. The apparatus can include means for receiving, from a radio access network node, an estimated active time of a user equipment. The apparatus can also include means for considering the user equipment as reachable during a period of time corresponding to the estimated active time.

### BRIEF DESCRIPTION OF THE DRAWINGS

For proper understanding of example embodiments, reference should be made to the accompanying drawings, wherein:

FIG. 1 illustrates an example of third generation partnership project mobile initiated connection only active time;

FIG. 2 illustrates an example of mobile initiated connection only with estimated active time of energy harvesting device, according to certain embodiments;

FIG. 3 illustrates a flow chart for behavior of an energy harvesting device, according to certain embodiments;

FIG. 4 illustrates a chart of estimated active time as a function of a harvested energy level and reference signal received power, according to certain embodiments; and

FIG. 5 illustrates an example block diagram of a system, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing estimated active time for paging reception for energy harvesting devices, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Low cost and low power devices for wide area Internet of things (IoT) communication may benefit many IoT applications. These use cases may be addressed by work of the third generation partnership project (3GPP) with regard to narrowband IoT (NB-IoT)/enhanced machine type communication (eMTC) and new radio (NR) reduced capability (RedCap). These IoT devices may consume tens or hundreds of milliwatts power during transceiving and may cost a few dollars. To achieve the objects of internet of everything, IoT devices with ten or even a hundred times lower cost and power consumption may be valuable, especially for a large number of applications that may rely on devices without batteries, sometimes referred to as batteryless or battery-free devices. There may be benefit in IoT technology that can support batteryless devices.

The number of IoT connections has been growing rapidly in recent years and may be hundreds of billions by 2030. With more and more things expected to be interconnected for improving production efficiency and increasing the comforts of life, there may be an increasing benefit from further reduction of size, cost, and power consumption for IoT devices. In particular, regular replacement of batteries for all the IoT devices may be impractical due to the tremendous consumption of material and labor. One option is to use energy harvested from environments to power IoT devices for self-sustainable communications, especially in applications with a huge number of devices, such as ID tags and sensors.

In the target use cases, there may be challenges in providing the capability of cooperating with energy harvesting considering limited device size. Cellular devices may consume tens or even hundreds of milliwatts power for transceiving processing. Taking an NB-IoT module for example, the typical current absorption for receive processing is currently about 60 mA, with a supply voltage higher than 3.1 V, and 70 mA for transmitting processing at 0 dBm transmit power. The output power provided by typical energy harvester may be below 1 milliwatt, considering the small size of a few square centimeters for practical devices. Since the available power is far less than the consumed power, it may be impractical to power cellular devices directly by energy harvesting in most cases.

One possible solution is to integrate energy harvesting with a rechargeable battery or supercapacitor. Both rechargeable batteries and supercapacitors may suffer from shortened lifetime in practical cases. It may be hard to provide constant charging current or voltage by energy harvesting, but longtime continuous charging may be needed, due to the very small output power from an energy harvester. Varying charging current and long term continuous charging may both be harmful to battery life. For a supercapacitor, its lifetime may be significantly reduced in high temperature environments. For example a supercapacitor may function properly for less than 3 years at 50 degrees Celsius.

Another impact may be that device size may be significantly increased.

Small size button batteries may only provide current of a few tens of milliamps. Thus, batteries with a much larger size, such as AA batteries, may be used to power cellular devices. In this case, the size of the battery may be even larger than the active portions of the module itself. To store energy for a proper duration of working, such as one second, the required capacitance of a supercapacitor may be at the level of a hundred milli-farads. The size of such supercapacitors may likewise be larger than the size of an NB-IoT module aside from the power source.

Rechargeable batteries and supercapacitors can each be more expensive than the module itself. Even purchased in large quantities, the cost of a suitable battery or supercapacitor may reach one or a few dollars, which may nearly double the cost of the device.

Radio-frequency identifier (RFID) is a technology that supports batteryless tags, which is one category of batteryless device. The power consumption of commercial passive RFID tags can be as low as 1 microwatt. A technique that enables such low power consumption can be envelope detection for downlink data reception, and backscatter communication for uplink data transmission. RFID is designed for short-range communications, and typical effective range is less than 10 meters. As the air interface of RFID has remained almost unchanged since 2005, the transmission scheme may be an obstacle to improving link budget and capability of supporting a scalable network. Nevertheless, RFID can demonstrate the extremely low power consumption of backscatter communication.

Passive IoT may be included in 5G NR. Both 3GPP and non-3GPP technologies, such as WiFi, Bluetooth, UWB, and LORA may benefit from techniques that provide low power consumption. A few or tens of microwatts power consumption can be achieved for passive tags based on or with modifications to each of these air interfaces. In contrast to RFID, there may be benefit in providing devices with long range communication capability. For example, a distance of a few hundred meters may be possible.

Energy harvesting devices (EHDs) may harvest energy from natural sources. The natural sources can include solar energy, environmental vibrations, or the like. The amount of harvested energy and stored energy may vary from device to device. The harvested energy does not need to be exclusively for the device's radio frequency (RF) modem. For example, the harvested energy could also be employed to power sensors on the device. Certain embodiments may help a network to support devices with reduced energy resources and with a high variability of the energy resources.

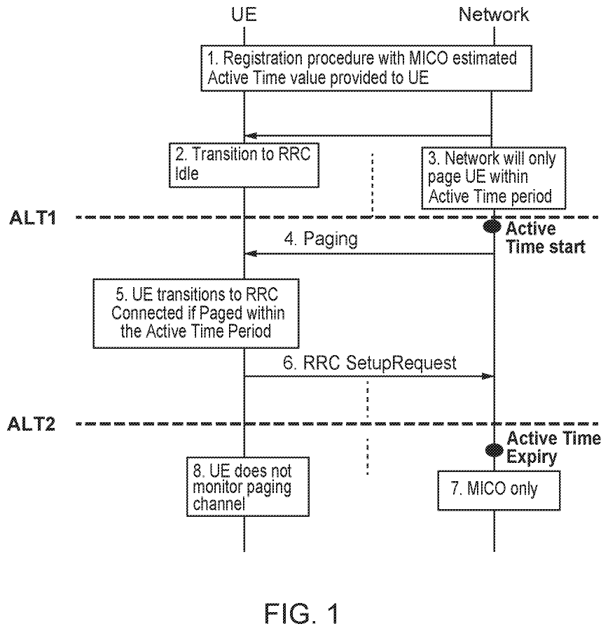

FIG. 1 illustrates an example of third generation partnership project mobile initiated connection only active time. One aspect that leads to high energy consumption for devices in RRC idle or inactive mode is the monitoring of the paging channel. 3GPP mechanisms to reduce such energy consumption can include early paging indication or mobile initiated connection only (MICO).

A device in MICO mode may not need to listen to the paging procedure in RRC idle. In order to further enable power savings for IoT devices, there can be a MICO mode with active time, as shown in FIG. 1.

In this MICO mode, at 1 in FIG. 1 the UE can request the access and mobility management function (AMF) during a registration procedure to activate MICO mode with an active time value. As part of the registration procedure, the AMF can allow the UE to operate in MICO mode and can assign an active time value to the UE. The UE can transition to RRC idle at 2. The AMF can consider the UE reachable for paging after the transition from RRC connected to RRC idle for the duration of the active time, as shown at 3 in FIG. 1.

Accordingly, after an active time starts, the network can page the UE at 4. The UE can, at 5, transition to RRC connected if paged within the active time period. At 6, the UE can provide an RRC setup request to the network. After the expiry of the active time, at 8 the UE may not monitor the paging channel. Moreover, the network can, at 7, consider the UE to be in MICO only mode.

While this MICO mode with active time can also be used for EHD, a value of active time set at registration may be rigid. It may be beneficial for such an active time value to be adapted based on the EHD harvested energy levels. It may not be guaranteed that when setting the active time value, the EHD would have actually have harvested the needed energy for connecting to network. Furthermore, these power saving gains may also be employed in RRC inactive mode, where many IoT devices may leverage the fast transition from low-activity state to ready to transmit and/or also allow the benefits of a small data transmission framework.

Certain embodiments address the situation in which an EHD transitions from RRC connected to RRC idle or inactive. More particularly, certain embodiments relate to how paging is to be monitored to efficiently employ a device's energy resources.

In certain embodiments, for UEs in RRC idle, the access and mobility management function may provide each NG-RAN node with paging attempt information that includes a paging attempt count and an intended number of paging attempts, as well as a next paging area scope. For UEs in RRC inactive, the serving NG-RAN node may also provide RAN paging attempt information. Each paged NG-RAN node can receive the same RAN paging attempt information during a paging attempt with the following content: paging attempt count, the intended number of paging attempts, and the next paging area scope. For MICO with active time, the AMF can determine the active time during registration.

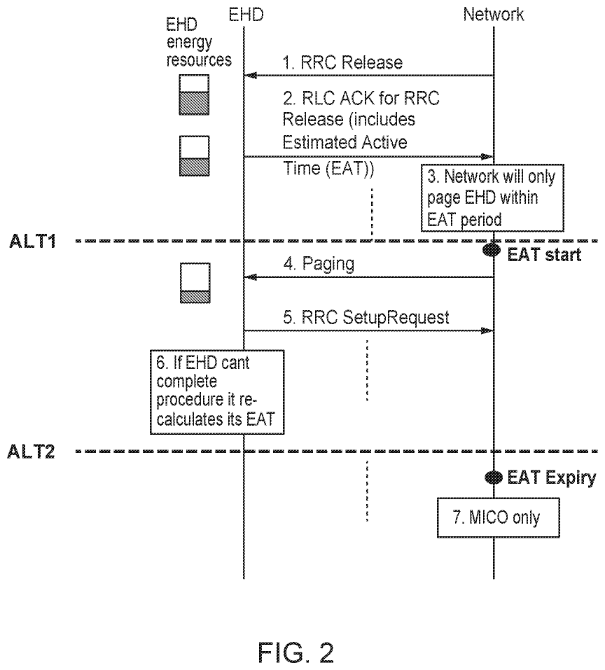

FIG. 2 illustrates an example of mobile initiated connection only with estimated active time of energy harvesting device, according to certain embodiments. Certain embodiments provide a method to allow for more dynamic values for the MICO estimated, without requiring non-access stratum (NAS) signaling between the EHD and the network. Certain embodiments may allow for the network and the EHD to be synchronized with respect to a value of MICO active time to employ with minimized signaling overhead. Thus, certain embodiments may permit efficient use of the EHD's harvested energy.

As shown in FIG. 2, at 1, the network may send an RRC release message to the EHD. For example, the RRC release message may be a message that releases, suspends, or otherwise triggers a transition from RRC connected to RRC idle/inactive.

As shown in FIG. 2, the EHD may have a first energy level when the RRC release is received, and a new, lower energy level at 2, when providing a radio link control (RLC) acknowledgement (ACK) of the RRC release message. The energy level is shown at the left side of FIG. 2 and the signaling is shown at the right side of FIG. 2. The acknowledgment message can include the estimated active time (EAT) of the EHD.

Thus, in certain embodiments, in response to an RRC release message at 1, at 2 the EHD can send an RLC ACK. The RLC ACK transmission from the EHD can include an indication of the EHD estimated active time. The EAT can be an estimation of the EHD corresponding to a duration, for example, how long the EHD would be able to monitor the paging channel based on currently harvested and/or otherwise available energy resources. This EAT may also take into account that if a paging is received within the allowed window, for example as shown at 4, the EHD may need to use at least some energy resources to respond to this paging procedure at 5.

If the EHD was transitioned to RRC idle, the NG-RAN node may forward the EHD EAT to the AMF, although this procedure is not explicitly shown in FIG. 2. Likewise, when the user equipment is transitioned to a radio resource control inactive state, the NG-RAN node can forward the estimated active time to at least one other NG-RAN node. NG-RAN nodes are non-limiting examples of an access node of any radio access network. The NG-RAN nodes can be restricted to paging the user equipment during the estimated active time. Thus, the forwarded EAT can be used to schedule pagings appropriately.

The AMF and/or the NG-RAN can employ the EAT as the period during which the EHD is reachable, as noted at 3.

At depletion of energy resources prior to the expiry of the configured EAT, as shown at 6, or at expiry of the configured EAT without depletion of energy resources, the EHD may update the EHD's EAT value for future transitions to RRC idle/inactive. The EHD can estimate the EAT in a variety of ways, as discussed below. At 7, after expiry of the EAT, the network can treat the EHD as operating in MICO only.

For EHD using MICO active time, the maximum EAT for MICO may not exceed the MICO active time set by the AMF during the registration procedure. For EHD not employing MICO, the NG-RAN could provide the AMF the value of EAT so the AMF could, for example, prioritize paging attempts and re-attempts within the EAT window of the EHD, although such communication between the NG-RAN and the AMF is not shown in FIG. 2.

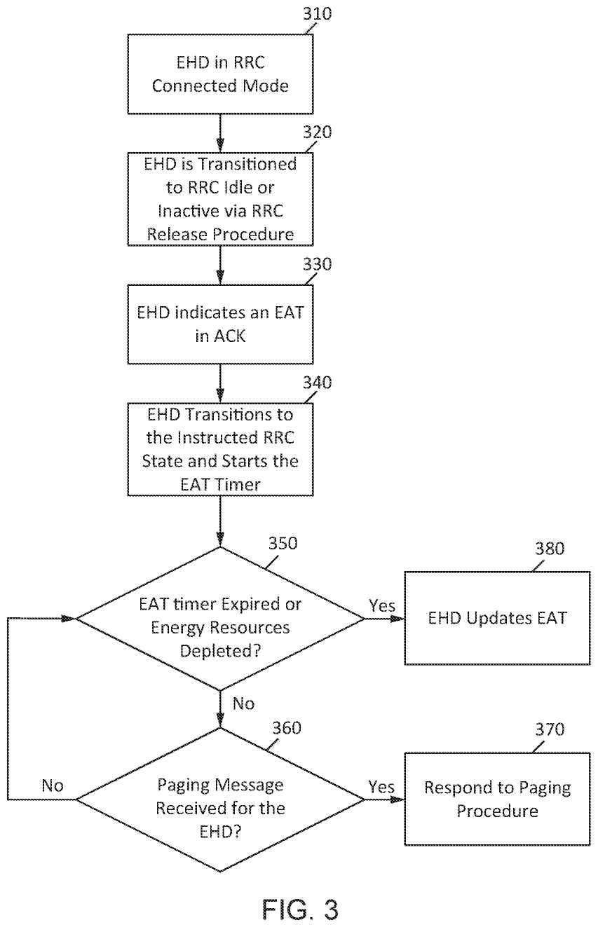

FIG. 3 illustrates a flow chart for behavior of an energy harvesting device, according to certain embodiments. At 310, the EHD may initially be in RRC connected mode and may receive an RRC release message from the network. This RRC release message may be requesting the EHD to release or suspend and thereby transition into RRC idle or RRC inactive state as shown at 320. Upon the reception of this message, the EHD may respond to the RRC release message with an ACK, such as an RLC ACK, to confirm the reception of the release message as shown at 330. The EHD may also include an indication of the EHD's EAT. For example, the EHD may include a MAC-CE within the physical downlink shared channel (PDSCH) transmitting the RLC ACK to indicate the EHD's EAT.

At 340, the EHD may complete the transition to the instructed RRC state and may start a timer, or provide a time offset, with the value of the EAT. At 350, there can be a determination made as to whether the EAT timer has expired or energy resources have been depleted. If the timer has not expired and energy resources are not depleted, at 360 the EHD can monitor for paging occasions. When paging is received, at 370 the EHD can respond to them in any desired way.

If the EHD energy resources are depleted prior to the expiry of the stated timer, then the EHD estimation of the EAT may have been too optimistic and may need to be corrected to a smaller value for future transitions to RRC idle/inactive state, as shown at 380.

If the stated timer expires and the EHD are high enough such that it could have monitored the paging channel for a longer period, the EHD may also update the EAT at 380. The EHD may also update the EAT if, at 370, the EHD fails to, for example, complete the transition to RRC connected.

The behavior described above pertains to EHD with or without MICO active time mode enabled. If MICO active time mode is not enabled for an EHD, the EAT can be used as indication to NG-RAN/AMF of the time window in which to expect a higher paging success rate to the EHD.

In certain embodiments, the EHD may derive a value of the estimated active time based on the EHD's current energy harvested levels and possibly also the EHD's current energy harvesting rate. The derived value of the timer may not only estimate energy to monitor the paging occasions but also for performing the follow up procedures related to a paging request.

While there may be other ways to calculate energy, in certain embodiments, the EHD may calculate energy based on a fixed amount of energy resources being reserved for responding to paging events. The EHD may use an initial value of the EAT equal to the value provided by the AMF during registration procedure, for active time. If the energy levels are depleted or fall below the threshold reserved for follow up procedures, the EHD can reduce the EHD's EAT by an established step size. If, at expiry of the EAT timer, the energy resources are above the threshold reserved for follow up procedures plus an additional margin, the EHD can increase the EAT by a certain step size. The step sizes for increasing and decreasing the EAT may be configured by the network semi-statically or may be configured in the EHD. Additionally, the values of the steps do not need to be the same, and one may be derived based on the other to minimize ping-pongs and allow for convergence. The additional margin could also be network configured or set individually per EHD and may ensure some hysteresis between increasing and decreasing EAT. The above described procedures for EAT time derivation can also be applied in scenarios where the EHD responds to a paging message but the EHD's energy resources are depleted before completing the procedure.

The use of AI/ML at the EHD to derive the EAT is permitted. However, in certain embodiments the use of AI/ML may be computationally intensive and may also consume significant power from the standpoint of the EHD.

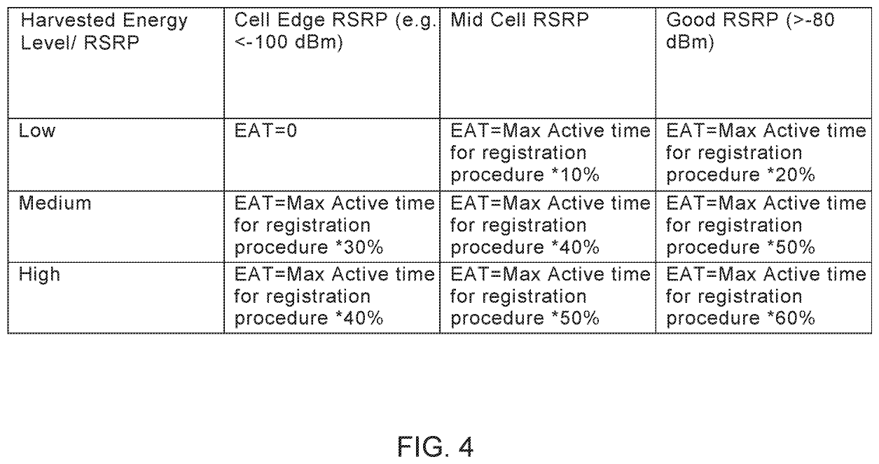

FIG. 4 illustrates a chart of estimated active time as a function of a harvested energy level and reference signal received power, according to certain embodiments. FIG. 4 illustrates various EAT values in a tabular form, although a function may be used instead of a lookup table to store or retrieve such information. As shown in FIG. 4, the EAT may be lowest when the harvested energy is low and the reference signal received power (RSRP) is low, such as −100 dBm, which may occur near a cell edge. On the other hand, when the RSPRR is about −80 dBm and the harvested energy level is high, the EAT may be at the highest value. In this example, the highest value is 60% of the maximum active time for a registration procedure. These values may depend on the capacity of the EHD, as well as the energy efficiency of the EHD. Other factors can also be considered.

In the example of FIG. 4, the EAT can have a 10% of maximum active time for registration procedure drop from a high harvested energy level to a medium harvested energy level, and an additional 30% drop to low harvested energy level. Likewise, the EAT can have a 10% of maximum active time for registration procedure drop from good RSRP to mid-cell RSPR and an additional 10% drop from mid-cell RSRP to cell-edge RSRP. It is not necessary to have such linearity in the calculation or table. Thus, FIG. 4 illustrates one, non-limiting example way for the EHD to derive the EAT based on RSRP and current energy levels.

The EHD can move or change in network propagation conditions and/or load balancing can cause cell reselections even for stationary devices. Thus, the RSRP of even stationary devices can vary during the time that the EHD remains in RRC idle or inactive. Accordingly, based on the UE mobility state, for example a number of cell re-selections in a period of time, or variance in serving cell RSRP, the EHD can apply a further correction factor to the numbers that are derived from the table shown in FIG. 4.

Accordingly, in certain embodiments, the estimated active time can be calculated based on a signal characteristic and a current energy level of the EHD. The signal characteristic can be RSRP, as shown in FIG. 4, or another parameter, such as reference signal received quality (RSRQ), or signal to interference plus noise ratio (SINR). Other characteristics can also be used.

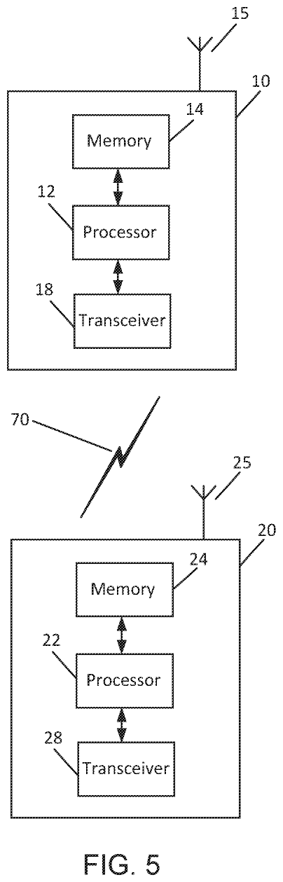

FIG. 5 illustrates an example of a system that includes an apparatus 10, according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may include an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a mid-haul interface, referred to as an F1 interface, and the DU(s) may have one or more radio unit (RU) connected with the DU(s) over a front-haul interface. The DU may be a logical node that includes a subset of the gNB functions, depending on the functional split option. It should be noted that one of ordinary skill in the art would understand that apparatus 10 may include components or features not shown in FIG. 5.

As illustrated in the example of FIG. 5, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 5, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to providing estimated active time for paging reception for energy harvesting devices.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be include any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein. The term “non-transitory,” as used herein, may correspond to a limitation of the medium itself (i.e., tangible, not a signal) as opposed to a limitation on data storage persistency (e.g., RAM vs. ROM).

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1-4, or any other method described herein. In some embodiments, as discussed herein, apparatus 10 may be configured to perform a procedure relating to providing estimated active time for paging reception for energy harvesting devices, for example.

FIG. 5 further illustrates an example of an apparatus 20, according to an embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 5.

As illustrated in the example of FIG. 5, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 5, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can include any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDM symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1-4, or any other method described herein. For example, in an embodiment, apparatus 20 may be controlled to perform a process relating to providing estimated active time for paging reception for energy harvesting devices, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, certain embodiments may allow a network and/or service provider to configure how different energy harvesting device types and capabilities can respond to paging and connection requests. Also, certain embodiments may allow energy harvesting devices to better decide how to efficiently utilize their scarce energy resources. Certain embodiments may avoid paging storms and repetitive dropped call procedures from the energy harvesting devices. Furthermore, certain embodiments may provide efficient utilization of network resources.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components that, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

ACK: Acknowledgement
AMF: Access and Mobility Management Function
DL: Downlink
EAT: Estimated Active Time
EHD: Energy Harvesting Device
IoT: Internet of Things
MAC: Medium Access Control
MAC-CE: MAC Control Element
MICO: Mobile Initiated Connection Only
NG-RAN: Next Generation RAN
PDCCH: Physical Downlink Control Channel
RAN: Radio Access Network
RLC: Radio Link Control
RRC: Radio Resource Control

1.-35. (canceled)

36. An energy harvesting device (EHD), comprising:
at least one processor; and
at least one memory storing instructions that, when executed by the at least one processor, cause the EHD at least to perform the following operations:
receiving a radio resource control (RRC) release message from a network, the radio resource control release message triggering a transitions from RRC connect to RRC idle or RRC inactive, the EHD comprising a first energy level upon receiving the RRC release message;
determining an estimated active time (EAT) for the EHD, wherein the EAT is an estimation of how long the EHD is able to monitor a paging channel based on currently harvested energy resources and otherwise available energy resources and based on a paging being received within an allowed window and follow up procedures related to paging requests, wherein determining the EAT comprises:
determining a harvested energy level and a reference signal received power (RSRP) for the EHD;
based on the RSRP being −80 dBm and the harvested energy level being above a high level threshold, setting the EAT to 60% of a maximum active time for a registration procedure;
sending a radio link control (RLC) acknowledgement of the RRC release message, the RLC acknowledgement comprising the EAT for the EHD, wherein the EHD comprises a second energy level upon sending the RLC acknowledgement, and wherein the second energy level is lower than the first energy level;
determining a depletion of energy resources prior to an expiry of the EAT sent in the acknowledgment message; and
based on the depletion of the energy resources prior to the expiry of the EAT sent in the acknowledgement message, updating the EAT from a time value sent in the acknowledgment message to a shorter time value for future transitions to RRC idle and RRC inactive.

37. The EHD of claim 36, wherein the instructions, when executed by the at least one processor, further cause the EHD to perform the following operations:
synchronizing the EHD with the network with respect to a value of mobile initiated connection only (MICO) active time to employ with minimized signaling overhead.

38. The EHD of claim 37, wherein, upon expiration of the EAT, the EHD is treated as operating in MICO only.

39. The EHD of claim 38, wherein a maximum EAT for MICO does not exceed a MICO active time set by a mobility management function (AMF) during the registration procedure.

40. The EHD of claim 39, wherein the EAT has a 10% of maximum active time for registration procedure drop from a high harvested energy level to a medium harvested energy level, an additional 30% drop to low harvested energy level, a 20% of maximum active time for registration procedure drop from −80 dBm RSRP to −100 dBM RSPR.

41. The EHD of claim 40, wherein when the EHD is in RRC idle, the AMF provides each next generation radio access network (NG-RAN) node with paging attempt information that includes a paging attempt count and an intended number of paging attempts, and a next paging area scope.

42. The EHD of claim 40, wherein when the EHD is in RRC inactive, a serving next generation radio access network (NG-RAN) node provides RAN paging attempt information.

43. A system comprising:
an energy harvesting device (EHD);
at least one processor; and
at least one memory storing instructions that, when executed by the at least one processor, cause the EHD at least to perform the following operations:
receiving a radio resource control (RRC) release message from a network, the radio resource control release message triggering a transitions from RRC connect to RRC idle or RRC inactive, the EHD comprising a first energy level upon receiving the RRC release message;
determining an estimated active time (EAT) for the EHD, wherein the EAT is an estimation of how long the EHD is able to monitor a paging channel based on currently harvested energy resources and otherwise available energy resources and based on a paging being received within an allowed window and follow up procedures related to paging requests, wherein determining the EAT comprises:
determining a harvested energy level and a reference signal received power (RSRP) for the EHD;
based on the RSRP being −80 dBm and the harvested energy level being above a high level threshold, setting the EAT to 60% of a maximum active time for a registration procedure;
sending a radio link control (RLC) acknowledgement of the RRC release message, the RLC acknowledgement comprising the EAT for the EHD, wherein the EHD comprises a second energy level upon sending the RLC acknowledgement, and wherein the second energy level is lower than the first energy level;
determining a depletion of energy resources prior to an expiry of the EAT sent in the acknowledgment message; and
based on the depletion of the energy resources prior to the expiry of the EAT sent in the acknowledgement message, updating the EAT from a time value sent in the acknowledgment message to a shorter time value for future transitions to RRC idle and RRC inactive.

44. The system of claim 43, wherein the instructions, when executed by the at least one processor, further cause the EHD to perform the following operations:
synchronizing the EHD with the network with respect to a value of mobile initiated connection only (MICO) active time to employ with minimized signaling overhead.

45. The system of claim 44, wherein, upon expiration of the EAT, the EHD is treated as operating in MICO only.

46. The system of claim 45, wherein a maximum EAT for MICO does not exceed a MICO active time set by a mobility management function (AMF) during the registration procedure.

47. The system of claim 46, wherein the EAT has a 10% of maximum active time for registration procedure drop from a high harvested energy level to a medium harvested energy level, an additional 30% drop to low harvested energy level, a 20% of maximum active time for registration procedure drop from −80 dBm RSRP to −100 dBM RSPR.

48. The system of claim 47, wherein when the EHD is in RRC idle, the AMF provides each next generation radio access network (NG-RAN) node with paging attempt information that includes a paging attempt count and an intended number of paging attempts, and a next paging area scope.

49. The system of claim 47, wherein when the EHD is in RRC inactive, a serving next generation radio access network (NG-RAN) node provides RAN paging attempt information.

50. A method comprising:
Receiving, by an energy harvesting device (EHD), a radio resource control (RRC) release message from a network, the radio resource control release message triggering a transitions from RRC connect to RRC idle or RRC inactive, the EHD comprising a first energy level upon receiving the RRC release message;
determining, by the EHD, an estimated active time (EAT) for the EHD, wherein the EAT is an estimation of how long the EHD is able to monitor a paging channel based on currently harvested energy resources and otherwise available energy resources and based on a paging being received within an allowed window and follow up procedures related to paging requests, wherein determining the EAT comprises:
determining a harvested energy level and a reference signal received power (RSRP) for the EHD;
based on the RSRP being −80 dBm and the harvested energy level being above a high level threshold, setting the EAT to 60% of a maximum active time for a registration procedure;
sending, by the EHD, a radio link control (RLC) acknowledgement of the RRC release message, the RLC acknowledgement comprising the EAT for the EHD, wherein the EHD comprises a second energy level upon sending the RLC acknowledgement, and wherein the second energy level is lower than the first energy level;
determining, by the EHD, a depletion of energy resources prior to an expiry of the EAT sent in the acknowledgment message; and
based on the depletion of the energy resources prior to the expiry of the EAT sent in the acknowledgement message, updating, by the EHD, the EAT from a time value sent in the acknowledgment message to a shorter time value for future transitions to RRC idle and RRC inactive.

51. The method of claim 50, further comprising:
synchronizing the EHD with the network with respect to a value of mobile initiated connection only (MICO) active time to employ with minimized signaling overhead.

52. The method of claim 51, wherein, upon expiration of the EAT, the EHD is treated as operating in MICO only.

53. The method of claim 52, wherein a maximum EAT for MICO does not exceed a MICO active time set by a mobility management function (AMF) during the registration procedure.

54. The method of claim 53, wherein the EAT has a 10% of maximum active time for registration procedure drop from a high harvested energy level to a medium harvested energy level, an additional 30% drop to low harvested energy level, a 20% of maximum active time for registration procedure drop from −80 dBm RSRP to −100 dBM RSPR.

55. The method of claim 54, wherein when the EHD is in RRC idle, the AMF provides each next generation radio access network (NG-RAN) node with paging attempt information that includes a paging attempt count and an intended number of paging attempts, and a next paging area scope; and
wherein when the EHD is in RRC inactive, a serving next generation radio access network (NG-RAN) node provides RAN paging attempt information.
